(19) United States
(12) Patent Application Publication
(10) Pub. No.: US 2017/0325107 A1
(43) Pub. Date: Nov. 9, 2017

(54) MANAGING INFRASTRUCTURE EQUIPMENT MAINTENANCE

(71) Applicant: T-Mobile USA, Inc., Bellevue, CA (US)

(72) Inventors: Michael John Prochniak, Mountain View, CA (US); Brandon Kannier, Walnut Creek, CA (US); Martin James Tall, Brentwood, CA (US); Matthew Bryan Taunton, Brentwood, CA (US)

(21) Appl. No.: 15/149,052

(22) Filed: May 6, 2016

(51) Int. Cl. H04W 24/04; H04B 17/318

(52) U.S. Cl. CPC H04W 24/04; H04B 17/318

(57) ABSTRACT

Systems and method for the management of infrastructure equipment utilizing intermediate performance thresholds and trend performance thresholds to characterize functionality of the infrastructure equipment according to collected performance information are provided. Infrastructure equipment performance information is collected and transmitted to an infrastructure management service. The infrastructure management service utilizes multiple performance thresholds to characterize functionality of the infrastructure equipment. By utilizing the characterization of the functionality of the infrastructure equipment, an infrastructure maintenance scheduler system can mitigate a potential interruption wireless network service by servicing infrastructure equipment prior to a hardware failure.

### BACKGROUND

Generally described, communication networks include various equipment to facilitate the operation of the communication network. In the context of a wireless communication network, a network service provider can provision network infrastructure equipment at various geographic locations to facilitate transmission and processing of wireless signals exchanged with mobile devices. In most wireless communication networks, various aspects of the infrastructure equipment can be configured based on utilization of software interfaces and applications that adjust the operation of the infrastructure equipment.

In some implementations, a wireless network can include a large number of individual infrastructure equipment that are distributed over various geographic areas forming the coverage area of the particular wireless network. Generally described, the infrastructure equipment can include a wide variety of components including various hardware components and associated software devices. Failure of the components of such infrastructure equipment can result in partial or complete loss of functionality of the wireless network.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a schematic block diagram of an illustrative communication network topology including one or more client computing devices, one or more third party data sources, one or more infrastructure equipment, and an infrastructure management service;

FIG. 2 is a schematic block diagram of an illustrative infrastructure equipment including a configuration application;

FIGS. 3A-3C are schematic block diagrams of the communication network of FIG. 1 illustrating the collection and processing of performance information for infrastructure equipment;

FIG. 4 is a flow diagram illustrative of an infrastructure performance information processing routine implemented by an infrastructure management service; and

FIG. 5 is a flow diagram illustrative of an infrastructure performance information processing routine implemented by an infrastructure management service.

### DETAILED DESCRIPTION

Generally described, the present application relates to the management of network infrastructure equipment. More specifically, aspects of the present application relate to the management of infrastructure equipment utilizing intermediate performance thresholds and trend performance thresholds to characterize functionality of the infrastructure equipment according to collected performance information. By utilizing the characterization of the functionality of the infrastructure equipment, an infrastructure maintenance scheduler system can mitigate a potential interruption wireless network service by servicing infrastructure equipment prior to a hardware failure.

In accordance with an illustrative embodiment, an infrastructure maintenance scheduler is provided for facilitating the generation and collection of performance information for a set of infrastructure equipment. The infrastructure maintenance scheduler system utilizes various data templates and scripting rules that are transmitted to individual collection agents on the infrastructure equipment. The collection agents can utilize hardware components, sensors, software components and the like to identify, collect, and transmit performance information related to the operation of the infrastructure equipment.

With continued reference to the illustrative example, once the infrastructure maintenance scheduler system has received the collected performance information, the infrastructure maintenance scheduler system can utilize two types of performance thresholds to characterize the functionality of the infrastructure equipment. Illustratively, the characterization of the functionality of the infrastructure can corresponds to characterization of “expected” or “normal” functionality or “unexpected” or “abnormal” functionality. The infrastructure maintenance scheduler system can then utilize the characterization of “unexpected” or “abnormal” functionality to be indicative that one or more components of the infrastructure equipment may be likely to fail. The infrastructure maintenance scheduler system can then generate notifications or other alerts that cause predictive maintenance of the identified infrastructure equipment. The predictive maintenance can include an identification of maintenance of the hardware or software components that generated the collected and analyzed performance information or hardware or software components that have been correlated to collected and analyzed performance information.

In one aspect, a first type of performance threshold can corresponds to an intermediate or immediate performance threshold that establish either a maximum or minimum value that can be directly compared to the instant collected performance information for a respective infrastructure equipment. By way of non-limiting examples, the intermediate performance thresholds can correspond to a measured gain of an antenna component, measured signal strength of a radio component, measured temperature of one or more components, timing information of one or more components, network connectivity measurements, error notifications or performance messaging generated by identified components, and the like.

In another aspect, a second type of performance threshold can corresponds to a trend performance threshold that establish either a maximum or minimum value that is compared to a set of performance information including the instant collected performance information and one or more historical collected performance information for a respective infrastructure equipment. By way of non-limiting examples, the trend performance thresholds can also correspond to a measured gain of an antenna component, measured signal strength of a radio component, measured temperature of one or more components, timing information of one or more components, network connectivity measurements, error notifications or performance messaging generated by identified components, and the like. In this example, however, the trend performance thresholds relate to identifying potential differences or other statistical analysis related to the current performance information and the historical performance information.

Although various aspects of the embodiments described in the present disclosure will focus, for purposes of illustration, on the management of infrastructure equipment, one skilled in the art will appreciate that the techniques disclosed herein may be applied to any number of software processes or applications. Further, although various aspects of the disclosure will be described with regard to illustrative examples and embodiments, one skilled in the art will appreciate that the disclosed embodiments and examples should not be construed as limiting.

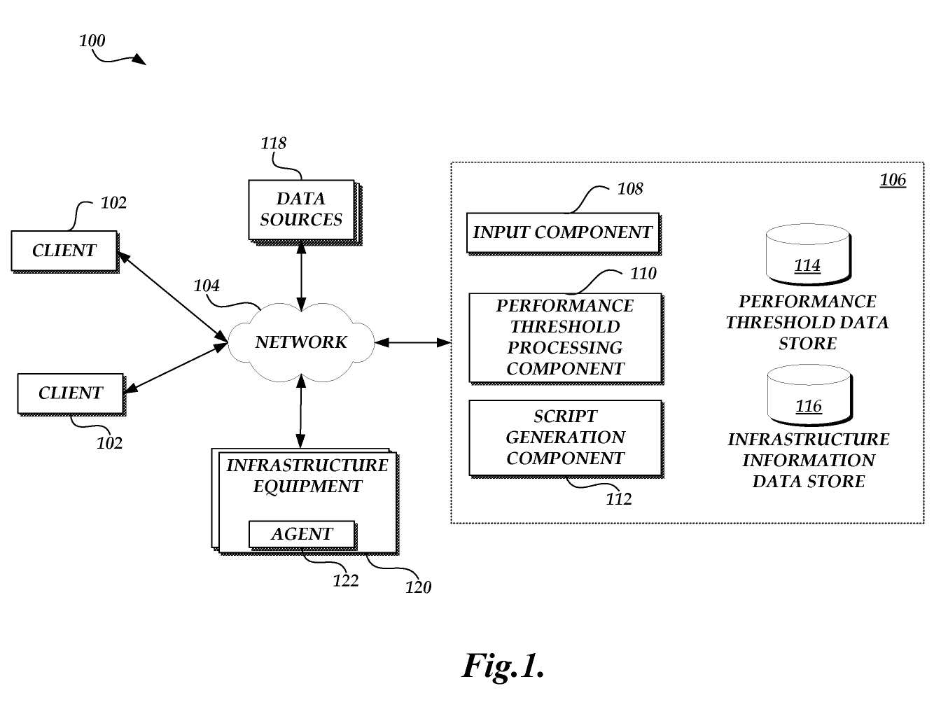

FIG. 1 is a block diagram illustrative of a networked computing environment 100 for managing infrastructure equipment in accordance with the present disclosure. As illustrated in FIG. 1, the networked computing environment 100 includes one or more client computing devices 102 (“client”) operable to transmit requests for configuration and management of network infrastructure equipment and provide information related to the configuration of network infrastructure equipment via a communications network 104. For example, the client computing devices 102 can be used to configure the collection of performance information on the infrastructure equipment or set values for one or more of the intermediate or trend performance thresholds.

In an illustrative embodiment, the client 102 can correspond to a wide variety of computing devices including personal computing devices, laptop computing devices, hand-held computing devices, terminal computing devices, mobile devices (e.g., mobile phones, tablet computing devices, etc.), wireless devices, various electronic devices and appliances, and the like. The client 102 includes necessary hardware and software components for establishing communications over the communications network 104. For example, the client 102 may be equipped with a network interface that facilitates communications via the network 104. The network 104 can be a publicly accessible network of linked networks, possibly operated by various distinct parties, such as the Internet. In other embodiments, the network 140 may include a private network, local area network (“LAN”), wide area network (“WAN”), cable network, satellite network, wireless telecommunications network, any other medium of computer data transfer, or some combination thereof. The client 102 may also have varied local computing resources such as a central processing unit, data store, input/output devices, a bus interface, memory, and so forth.

The networked computing environment 100 may also include an infrastructure management service 106 for generating executable code, such as scripts, that can cause the collection of performance information in infrastructure equipment, obtain data inputs related to infrastructure equipment and characterize functionality of respective infrastructure equipment according to performance thresholds. As illustrated in FIG. 1, the infrastructure management service 106 can include an input component 108 or application for obtaining information from client 102 and infrastructure equipment, networked data stores, local data stores, or third party data providers. The infrastructure management service 106 can further include a performance thresholds processing component 110 or application for processing received performance information according to two or more types of performance thresholds and characterizing functionality of the infrastructure equipment. The infrastructure management service 106 can further include a script generation component 112 or application generating executable code utilized by the infrastructure equipment to collect specific performance information and return the collected information to the infrastructure management service 106.

Illustratively, the infrastructure management service 106 can be implemented on one or more physical computing devices. The physical computing devices include necessary hardware and software components for implementing the components/applications identified above as well as other applications or components. Such local computing resources such as a central processing unit, data store, input/output devices, a bus interface, memory, and so forth. Additional software such as networking software, virtualization software, operating system, and other applications are further included in the physical computing device.

The infrastructure management service 106 can also include or be associated with a performance threshold data store 114 that provides the performance thresholds utilized to characterize functionality. The infrastructure management service 106 can further include an infrastructure information data store 116 for maintaining collected performance information that will be utilized as historical performance information. One skilled in the relevant art will appreciate that will the data stores 114 and 116 are depicted as a single data store, the data stores may encompass multiple data stores implemented in a distributed manner, a centralized manner or a combination thereof.

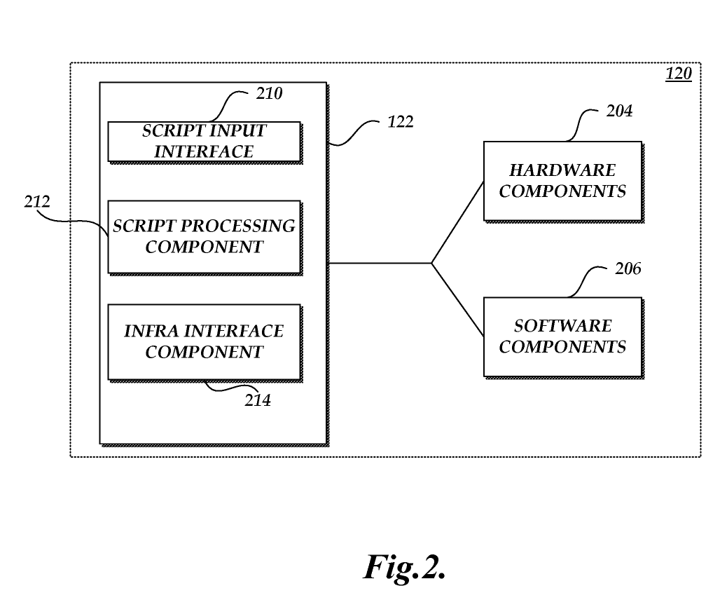

With continued reference to FIG. 1, the networked computing environment 100 can further include various third party data sources 118 for optionally transmitting collected performance data or performance thresholds utilized in the characterization of infrastructure equipment. By way of illustrative example, a third party data source 118 may provide environmental information, such as temperature information, humidity, wind conditions, etc., that may be utilized to determine performance information or may be utilized in the processing of collected performance information. In other example, a third party data source 118 may also provide communication network traffic or network connectivity information that may be utilized to determine performance information or may be utilized in the processing of collected performance information. Additionally, as illustrated in FIG. 1, the networked computing environment 100 can further include a set of infrastructure equipment the form at least a portion of a wireless communication network and which receive and process performance scripts generated by the infrastructure management service 106. The infrastructure equipment 120 includes an agent 122 for managing the collection and processing of the collected performance information. Illustrative infrastructure equipment 120 will be described with regard to FIG. 2, below.

Further, the modules or components illustrated in FIG. 1 may include additional components, systems, and subsystems for facilitating the methods and processes. For example, in various embodiments, the client 102 may be centralized in one computing device, distributed across several computing devices, implemented by one or more virtual machine instances, or distributed through a network. Likewise, the infrastructure management service 106 may be implemented in or more physical computing devices, virtual computing devices, and the like.

With reference now to FIG. 2, a schematic block diagram of illustrative infrastructure equipment 120 including a performance information application 122 will be described. Illustratively, infrastructure equipment 120 can be embodied in a variety of communication network equipment and combination of communication network equipment. For purposes of the present application, the various hardware and software functionality of infrastructure equipment will not be described in detail. Rather, illustrative aspects of the functionality of infrastructure equipment to obtain and process executable code provided by the infrastructure management service 106 to collect performance information will be described.

The infrastructure equipment 120 includes necessary hardware and software components for establishing communications over the communications network 104. For example, the infrastructure equipment 120 may be equipped with a network interface that facilitates communications via the network 104. The infrastructure equipment 120 may also have varied local computing resources such as a central processing unit, data store, input/output devices, a bus interface, memory, and so forth. As illustrated in FIG. 1, the infrastructure equipment 120 can include a performance information application 122. The functionality of the performance information application 122 can include a script input interface 210 or application for obtaining executable code or other information from the infrastructure management service 106. The performance information application 122 can further include a script processing component 212 or application for processing the data received in collection scripts and identifying various hardware or software aspects of the infrastructure equipment 120 that will provide the requested performance information. The performance information application 122 can further include an interface component 214 or application for collecting performance information from hardware 204 or software 206 components utilized in the operation of the infrastructure equipment 120. In some embodiments, the interface component 214 can interface with existing hardware 204 or software 206 to collect performance information. In other embodiments, the interface component 214 can interface with custom sensors, hardware components, or software components that have been implemented or configured specifically for purposes of collecting performance information. For example, the interface component 214 may interface with a temperature sensor configured specifically to provide temperature-based performance information to the infrastructure management service 106. One skilled in the art will appreciate that the infrastructure equipment may have more or fewer components than those depicted in illustrative FIG. 2.

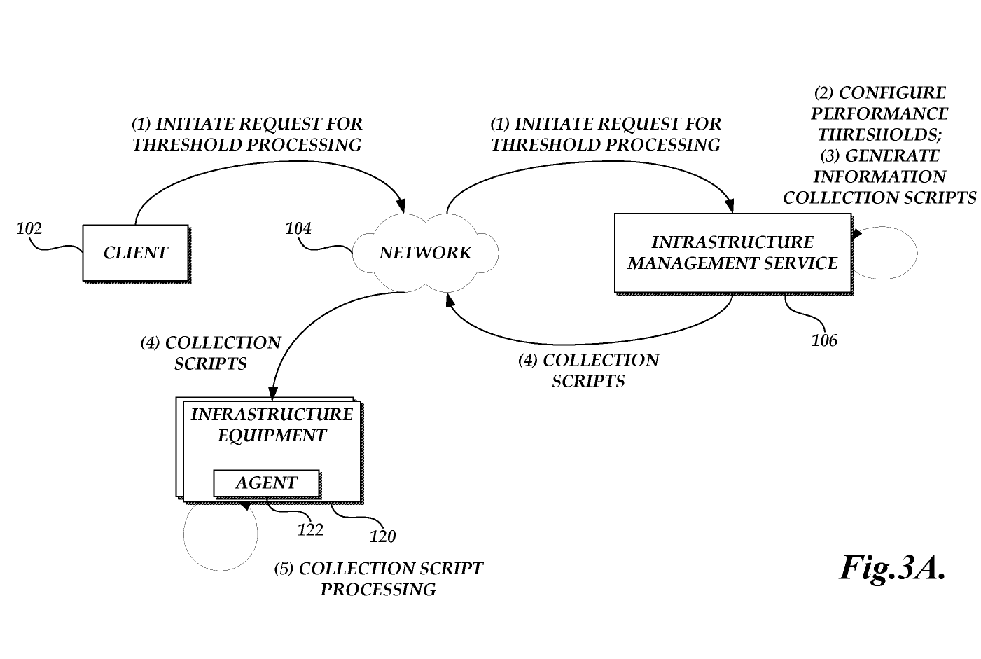

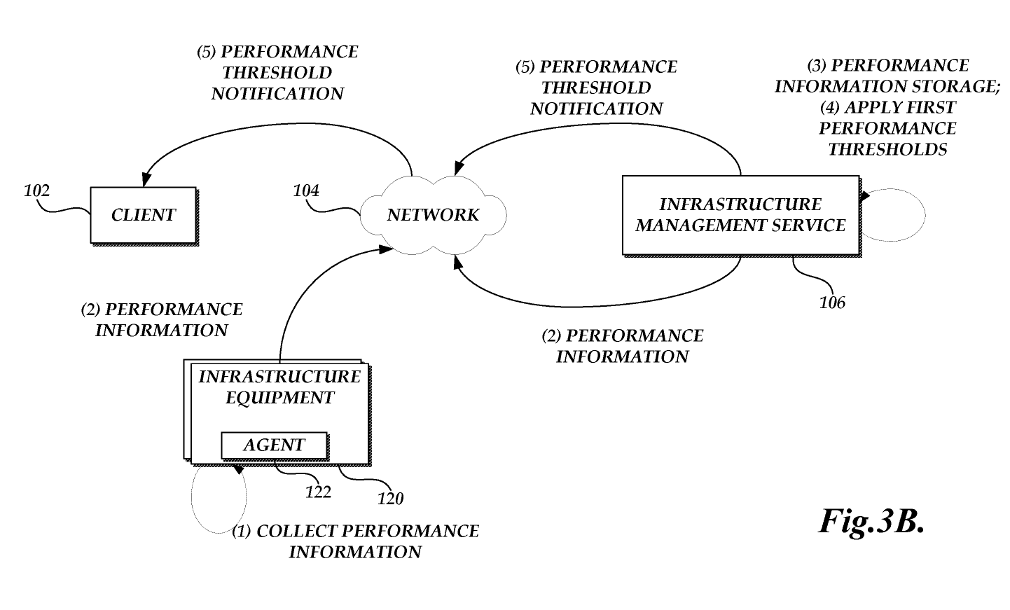

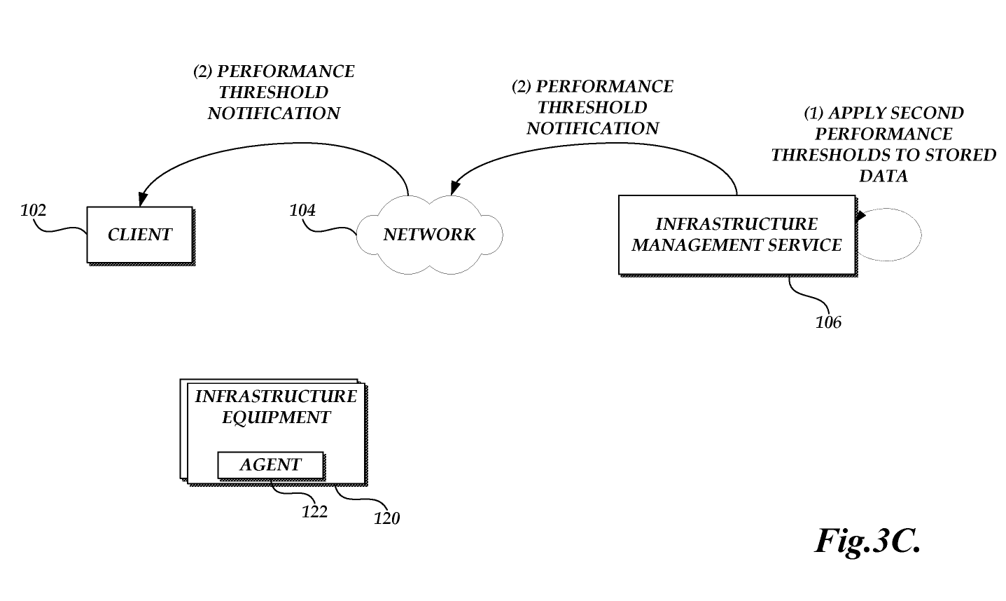

With reference now to FIGS. 3A-3C, block diagrams of the network topology of FIG. 1 illustrating the collection and processing performance information for infrastructure equipment will be described. With reference to FIG. 3A, at (1), a client 102 initiates the process by transmitting a request for performance threshold processing for a defined set of infrastructure equipment. In one aspect, the process may be instantiated at any point by selection a control of a graphical user interface generated by an application on the client 102. In other aspects, the process may also be instantiated as part of integrated process related to provisioning infrastructure equipment, or otherwise implementing an update. The request can illustratively include information sufficient to identify one or more performance thresholds of the infrastructure equipment to be configured and one or more data sources that will be utilized to collect performance information from the infrastructure equipment. In other embodiments, profile information accessed via authentication may also be the source of at least a portion of the identification of the performance thresholds. For example, user configuration profiles can identify performance thresholds that have been pre-configured for one or more infrastructure equipment without requiring specification in the request.

At (2), the infrastructure management service 106 receives the request and processes the request to determine one or more performance thresholds that will be applied against collected performance information from a set of infrastructure equipment. In one embodiment, the infrastructure management service 106 can identify one or more intermediate performance thresholds that will be used to evaluate immediately collected performance information. In another embodiment, the infrastructure management service 106 can identify one or more trend performance thresholds that will be used to evaluate collected performance information in conjunction with historical collected performance information. In some embodiments, the infrastructure management service 106 can process any selected performance threshold information to validate that the selected performance information threshold or to ensure that selected performance information thresholds are not otherwise compatible. For example, the infrastructure management service 106 may determine that one or more performance information thresholds may not be applicable to specific infrastructure equipment or may other yield inconsistent or inaccurate results. Illustratively, the infrastructure management service 106 can also identify the notification or alerts that will be generated based on a processing of the performance thresholds.

At (3), the infrastructure management service 106 generates performance information collection scripts. Illustratively, the collection scripts can correspond to computer-executable code that enables the performance information application 122, or agent, to identify the performance information to collect, the frequency of collection of the performance information, the schedule for transmission/reporting, and any additional protocols/processes for transmitting the collected performance information. At (4), the performance information scripts are transmitted to an identified set of infrastructure equipment. At (5), individual infrastructure equipment 120 execute the performance information collection scripts and initiate the collection of performance information as specified by the infrastructure management service 106. For example, the performance information application 122 can be configured to collect performance information continuously during the operation of the infrastructure equipment 120 and report the collected performance information on a daily basis to the infrastructure management service 106.

Turning to FIG. 3B, an embodiment for processing collected performance information utilizing intermediate performance thresholds will be described. At (1) the performance information application 122 generates the collected performance information. At (2), the performance information application 122 transmits the collected performance information. In one embodiment, the collected performance information may be transmitted immediately as it is received (e.g., substantially real-time). In other embodiments, the performance information application 122 may store collected performance information and transmit the collected performance information on a defined schedule. At (3), the infrastructure management service 106 stores the collected performance information in the information infrastructure data store 116. In some embodiments, the infrastructure management service 106 may process the collected performance information, such as by statistical normalization, removing outlier information, and the like.

Illustratively, the specific timing of the processing of collected performance data according to intermediate performance thresholds may be based on receipt of the performance data (e.g., responsive to the collection of performance data), the receipt of a threshold amount of performance data, the expiration of a minimal or maximum amount of time, or other additional criteria. At (4), the infrastructure management service 106 identifies one or more applicable intermediate performance thresholds and applies the identified intermediate performance thresholds in view of the collected performance information. As previously described, an intermediate performance threshold can establish either a maximum or minimum value that can be directly compared to the collected performance information. Based on the intermediate performance thresholds, the result of processing the collected performance information can be utilized to characterize the functionality of individual infrastructure equipment. The intermediate performance thresholds can correspond to a measured gain of an antenna component, measured signal strength of a radio component, measured temperature of one or more components, timing information of one or more components, network connectivity measurements, and the like. By way of a first illustrative example, an intermediate performance threshold related an antenna component would correspond to a minimum measured gain for transmission, such as 15 dB. In a second illustrative example, an intermediate performance threshold related a radio component would correspond to a maximum received signal strength indicator, such as 1.6 rssi. In a third illustrative example, an intermediate performance threshold related an internal component with a propensity to generate heat during operation, such as an amplifier, may be a maximum measured temperature, such as 140 degrees F. Similar performance thresholds can be applied for other types of performance information, such as network data throughput for networking equipment, additional signal strength or transmission efficiency parameters, timing information for chipset, communications generated by components that are indicative of parameters of operations or error messaging, and the like.

As previously described, the infrastructure management service 106 can characterize the functionality of the infrastructure equipment based on application of the intermediate performance thresholds. More specifically, in one embodiment, the characterization of the functionality can be indicative of an expected, typical, or tolerable operation of the infrastructure equipment 120. For example, if a temperature reading is below the maximum threshold, the infrastructure management service 106 could characterize the functionality as normal or otherwise acceptable. In another embodiment, the characterization of the functionality can be indicative of an atypical or abnormal such that the infrastructure management service 106 can associate the infrastructure equipment as likely to have malfunctioning equipment or equipment that should be serviced. Illustratively, the processing of the intermediate performance threshold will occur prior to a hardware failure that may damage additional components/equipment or that would otherwise result in longer infrastructure unavailability. At (5), the infrastructure management service 106 can generate performance threshold notifications to the client 102 (or multiple clients. The notifications can corresponds to reporting type notifications of the results of applying the intermediate performance thresholds. The notifications can also correspond to communications utilized to schedule a service for the infrastructure equipment 120 and can identify the specific intermediate performance thresholds utilized by the infrastructure management service 106, the results of the processing of the intermediate performance thresholds and the identification of specific components/equipment that need to be serviced. The notifications can further identify particular components of the infrastructure equipment that may need servicing, such as the components that generated the collected performance data or components that have been correlated to the collected performance data.

Turning to FIG. 3C, an embodiment for processing collected performance information utilizing trend performance thresholds will be described. As described in FIG. 3B, the infrastructure management service 106 may have already received the immediately collected performance information in order to process the intermediate performance thresholds. In this embodiment, the infrastructure management service 106 will consider the immediately collected performance information along with historical collected performance information that is maintained by the infrastructure management service 106. The timing of the trend performance thresholds can vary based on an amount of time that has transpired, the amount of performance information that has been collected, the receipt of a request for processing trend performance data or the evaluation of any additional criteria.

At (1), the infrastructure management service 106 identifies one or more applicable trend performance thresholds and applies the identified trend performance thresholds in view of the collected performance information. As previously described, a trend performance threshold that establish either a maximum or minimum value that is compared to a set of performance information including the instant collected performance information and one or more historical collected performance information for a respective infrastructure equipment. By way of non-limiting examples, the trend performance thresholds can also correspond to a measured gain of an antenna component, measured signal strength of a radio component, measured temperature of one or more components, timing information of one or more components, network connectivity measurements, and the like. In this example, however, the trend performance thresholds relate to identifying potential differences or other statistical analysis related to the current performance information and the historical performance information.

By way of a first illustrative example, a trend performance threshold related to an antenna component would relate to a range of acceptable gain differences for performance information collected over a defined period of time. For example, a threshold of +/−2 dB gain differences for transmissions over a two week time frame. In a second illustrative example, a trend performance threshold related to a radio component would correspond to a range of acceptable signal strength indicator differences over a defined period of time. For example, a threshold of +/−2.5 rssi over a two week window. In a third illustrative example, a trend performance threshold related to internal components with a propensity to generate heat during operation, such as an amplifier, may be a range of temperature readings over a defined period of time. For example, a threshold of +/−15 degrees F. over a two week window. Similar performance thresholds can be applied for other types of performance information, such as network data throughput for networking equipment, additional signal strength or transmission efficiency parameters, timing information for chipset, communications generated by components that are indicative of parameters of operations or error messaging, and the like. Additionally, although the above described trend performance thresholds match with a corresponding intermediate performance threshold, the intermediate and trend performance thresholds do not necessarily need to match.

As previously described, the infrastructure management service 106 can characterize a second functionality of the infrastructure equipment based on application of the trend performance thresholds. In a manner described with regard to intermediate performance thresholds, in one embodiment, the characterization of the functionality can be indicative of an expected, typical, or tolerable operation of the infrastructure equipment 120. For example, if the differences in antenna component gains over two weeks' worth of data is not above 2 dB, the infrastructure management service 106 could characterize the second functionality as normal or otherwise acceptable. In another embodiment, the characterization of the second functionality can be indicative of an atypical or abnormal such that the infrastructure management service 106 can associate the infrastructure equipment as likely to have malfunctioning equipment or equipment that should be serviced. Illustratively, the processing of the trend performance threshold will occur prior to a hardware failure that may damage additional components/equipment or that would otherwise result in longer infrastructure unavailability. Additionally, the trend performance threshold processing may achieve a characterization of the functionality for a specific infrastructure equipment that does not match the characterized functionality based on intermediate performance threshold. For example, the infrastructure management service 106 can determine that no individual performance information results in a characterization of abnormal, but a comparison of multiple readings results in characterization of abnormal based on progressing degradation of the performance of the infrastructure equipment.

At (2), the infrastructure management service 106 can generate performance threshold notifications to the client 102 (or multiple clients. The notifications can corresponds to reporting type notifications of the results of applying the trend performance thresholds. The notifications can also correspond to communications utilized to schedule a service for the infrastructure equipment 120 and can identify the specific intermediate performance thresholds utilized by the infrastructure management service 106, the results of the processing of the intermediate performance thresholds and the identification of specific components/equipment that need to be serviced. The notifications can further identify particular components of the infrastructure equipment that may need servicing, such as the components that generated the collected performance data or components that have been correlated to the collected performance data.

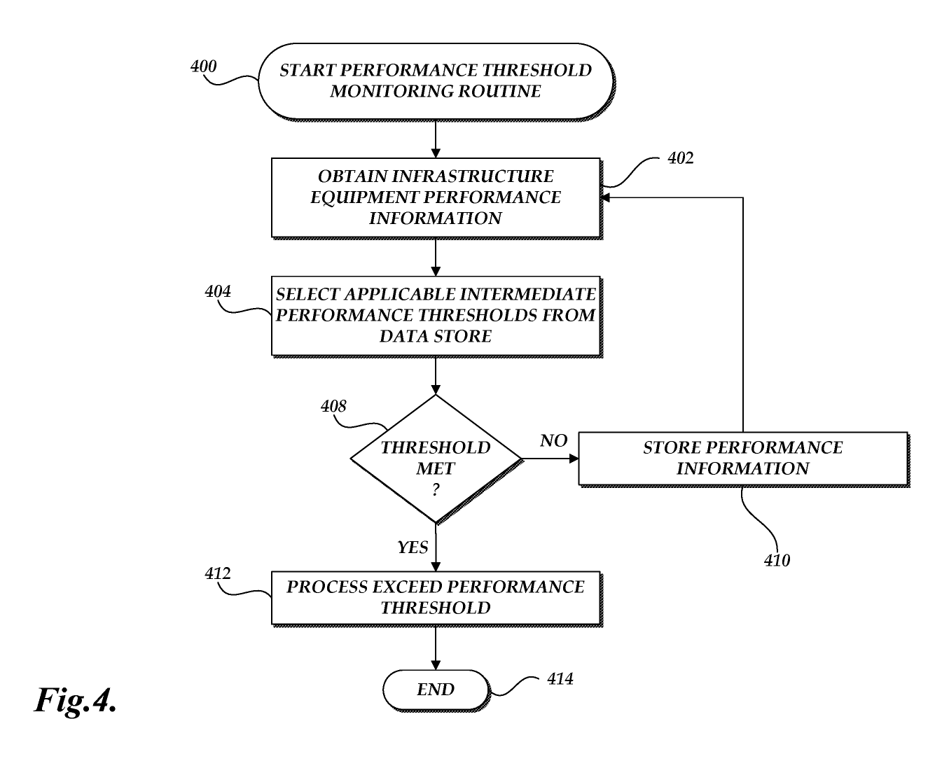

FIG. 4 is a flow diagram illustrative of an infrastructure performance information processing routine 400 implemented by an infrastructure management service 106. Routine 400 will be discussed with regard to the processing of intermediate performance thresholds. Illustratively, routine 400 can implemented once the performance information application 122 on the infrastructure equipment generates and transmits collected performance information. As previously described, in some embodiments, the infrastructure management service 106 may process the collected performance information, such as by statistical normalization, removing outlier information, and the like. The specific timing of the processing of collected performance data may be based on receipt of the performance data (e.g., responsive to the collection of performance data), the receipt of a threshold amount of performance data, the expiration of a minimal or maximum amount of time, or other additional criteria. At block 402, the infrastructure management service 106 obtains the infrastructure performance information.

At block 404, the infrastructure management service 106 identifies and selects one or more applicable intermediate performance thresholds and applies the identified intermediate performance thresholds in view of the collected performance information. As previously described, an intermediate performance threshold can establish either a maximum or minimum value that can be directly compared to the collected performance information. Based on the intermediate performance thresholds, the result of processing the collected performance information can be utilized to characterize the functionality of individual infrastructure equipment. The intermediate performance thresholds can correspond to a measured gain of an antenna component, measured signal strength of a radio component, measured temperature of one or more components, timing information of one or more components, network connectivity measurements, and the like.

At decision block 406, a test is conducted to determine whether an intermediate performance threshold has been met. As previously described, the infrastructure management service 106 can characterize the functionality of the infrastructure equipment based on application of the intermediate performance thresholds. More specifically, in one embodiment, the characterization of the functionality can be indicative of an expected, typical, or tolerable operation of the infrastructure equipment 120. For example, if a temperature reading is below the maximum threshold, the infrastructure management service 106 could characterize the functionality as normal or otherwise acceptable. In another embodiment, the characterization of the functionality can be indicative of an atypical or abnormal such that the infrastructure management service 106 can associate the infrastructure equipment as likely to have malfunctioning equipment or equipment that should be serviced. Illustratively, the processing of the intermediate performance threshold will occur prior to a hardware failure that may damage additional components/equipment or that would otherwise result in longer infrastructure unavailability. If the collected performance information does not meet (or exceed) a threshold, at block 410, the infrastructure management service 106 stores (or causes to be stored) the collected performance information for utilization as historical performance information. The routine 400 returns to block 402 to process additional intermediate performance thresholds or additional collected performance information.

alternatively at decision block 408, if an intermediate performance threshold has been met (or exceed), at block 412, the infrastructure management service 106 processes the exceeded intermediate performance threshold. Illustratively, the infrastructure management service 106 can generate performance threshold notifications to the client 102 (or multiple clients. The notifications can corresponds to reporting type notifications of the results of applying the intermediate performance thresholds. The notifications can also correspond to communications utilized to schedule a service for the infrastructure equipment 120 and can identify the specific intermediate performance thresholds utilized by the infrastructure management service 106, the results of the processing of the intermediate performance thresholds and the identification of specific components/equipment that need to be serviced. As previously described, the notifications can further identify particular components of the infrastructure equipment that may need servicing, such as the components that generated the collected performance data or components that have been correlated to the collected performance data. For example, a particular error message received from a first component in the infrastructure equipment may be correlated to a characterization of a second component being likely to fail and causing the generation of the error message on the first component.

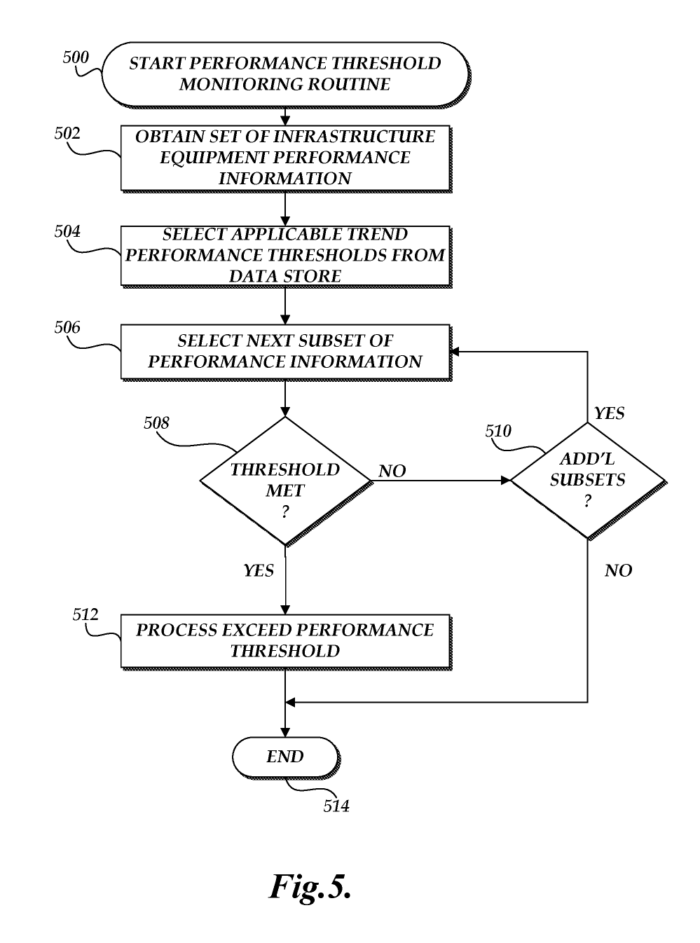

As described previously, once the performance information has been collected and processed against intermediate performance thresholds, the infrastructure management service 106 can further process one or more trend performance thresholds. With reference now to FIG. 5, an infrastructure performance information processing routine 500 implemented by an infrastructure management service 106 will be described. Routine 500 will be discussed with regard to the processing of trend performance thresholds. Illustratively, routine 500 can implemented once the performance information application 122 on the infrastructure equipment generates and transmits collected performance information. Additionally, routine 500 may be implemented subsequent the processing of the intermediate performance thresholds or in conjunction with the processing of the intermediate performance thresholds. As previously discussed, the timing of the processing of trend performance thresholds, as illustrated in FIG. 5, can vary based on an amount of time that has transpired, the amount of performance information that has been collected, the receipt of a request for processing trend performance data or the evaluation of any additional criteria.

At block 502, the infrastructure management service 106 obtains a set of infrastructure equipment information. Illustratively, the set of performance information can corresponds to a set of common performance information collected over a defined period of time. The set can include all performance information provided by infrastructure equipment. In other embodiments, the set can include historical information that corresponds to representative performance information, statistically significant performance information, average or normalized information, and the like.

At block 504, the infrastructure management service 106 identifies one or more applicable trend performance thresholds and applies the identified trend performance thresholds in view of the collected performance information. As previously described, a trend performance threshold that establish either a maximum or minimum value that is compared to a set of performance information including the instant collected performance information and one or more historical collected performance information for a respective infrastructure equipment. By way of non-limiting examples, the trend performance thresholds can also correspond to a measured gain of an antenna component, measured signal strength of a radio component, measured temperature of one or more components, timing information of one or more components, network connectivity measurements, and the like. In this example, however, the trend performance thresholds relate to identifying potential differences or other statistical analysis related to the current performance information and the historical performance information.

At block 506, the infrastructure management service 106 selects the next subset of performance information. Illustratively, since trend performance thresholds correspond to a comparison of the current performance information to historical collected performance information, the infrastructure management service 106 can iteratively compare the current performance information to a set of historical performance information. At decision block 508, a test is conducted to determine whether a trend performance threshold has been met (or exceeded). By way of a first illustrative example, a trend performance threshold related to an antenna component would relate to a range of acceptable gain differences for performance information collected over a defined period of time. In a second illustrative example, a trend performance threshold related to a radio component would correspond to a range of acceptable signal strength indicator differences over a defined period of time. In a third illustrative example, a trend performance threshold related to internal components with a propensity to generate heat during operation, such as an amplifier, may be a range of temperature readings over a defined period of time. Similar performance thresholds can be applied for other types of performance information, such as network data throughput for networking equipment, additional signal strength or transmission efficiency parameters, timing information for chipset, and the like. Additionally, although the above described trend performance thresholds match with a corresponding intermediate performance threshold, the intermediate and trend performance thresholds do not necessarily need to match.

As previously described, the infrastructure management service 106 can characterize a second functionality of the infrastructure equipment based on application of the trend performance thresholds. In a manner described with regard to intermediate performance thresholds, in one embodiment, the characterization of the functionality can be indicative of an expected, typical or tolerable operation of the infrastructure equipment 120. For example, if the differences in antenna component gains over two weeks' worth of data is not above 2 dB, the infrastructure management service 106 could characterize the second functionality as normal or otherwise acceptable. In another embodiment, the characterization of the second functionality can be indicative of an atypical or abnormal such that the infrastructure management service 106 can associate the infrastructure equipment as likely to have malfunctioning equipment or equipment that should be serviced. Illustratively, the processing of the trend performance threshold will occur prior to a hardware failure that may damage additional components/equipment or that would otherwise result in longer infrastructure unavailability. Additionally, the trend performance threshold processing may achieve a characterization of the functionality for a specific infrastructure equipment that does not match the characterized functionality based on intermediate performance threshold. For example, the infrastructure management service 106 can determine that no individual performance information results in a characterization of abnormal, but a comparison of multiple readings results in characterization of abnormal based on progressing degradation of the performance of the infrastructure equipment.

If at decision block 508, the trend performance threshold has not been met (or exceeded), at decision block 510, a test is conducted to determine whether there is additional performance information in the set of performance information to be evaluated against the trend performance thresholds. If so, the routine 500 returns to block 506 where the infrastructure management service 106 selects the next subset of performance information to evaluate/process. If no additional subsets exist at decision block 510, the routine 500 terminates at block 514.

Returning to decision block 508, if a trend performance threshold has been met (or exceed), at block 512, the infrastructure management service 106 processes the exceeded intermediate performance threshold. Illustratively, the infrastructure management service 106 can generate performance threshold notifications to the client 102 (or multiple clients. The notifications can corresponds to reporting type notifications of the results of applying the trend performance thresholds. The notifications can also correspond to communications utilized to schedule a service for the infrastructure equipment 120 and can identify the specific intermediate performance thresholds utilized by the infrastructure management service 106, the results of the processing of the intermediate performance thresholds and the identification of specific components/equipment that need to be serviced. The notifications can further identify particular components of the infrastructure equipment that may need servicing, such as the components that generated the collected performance data or components that have been correlated to the collected performance data. The routine 500 terminates at block 514.

Depending on the embodiment, certain acts, events, or functions of any of the methods described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules and method elements described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. A storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

1. A method for managing infrastructure equipment comprising:
obtaining performance information for a set of infrastructure equipment, wherein the performance information corresponds to data collected during operation of the infrastructure equipment in a wireless network;
storing the set of infrastructure equipment; and
for individual infrastructure equipment in the set of infrastructure equipment:
identifying one or more intermediate performance thresholds corresponding to performance information collected from the respective infrastructure equipment;
characterizing a functionality of the respective infrastructure equipment based on applying the identified one or more intermediate performance thresholds;
generating a notification based on a characterization of the functionality as like to fail;
identifying one or more trend performance thresholds corresponding to a set of performance information collected from the respective infrastructure equipment, wherein the set of performance information includes at least one historical performance information;
characterizing a second functionality of the respective infrastructure equipment based on applying the identified one or more trend performance thresholds; and
generating a notification based on a characterization of the second functionality as like to fail.

2. The method as recited in claim 1, wherein the performance information corresponds to radio signal information associated with the respective infrastructure equipment.

3. The method as recited in claim 1, wherein the performance information corresponds to temperature information associated with the respective infrastructure equipment.

4. The method as recited in claim 1, wherein the performance information corresponds to information associated with identifiable components of the respective infrastructure equipment.

5. The method as recited in claim 1, wherein characterizing the second functionality of the respective infrastructure equipment based on applying the identified one or more trend performance thresholds includes:
determining a difference between a current performance information and a historical performance information; and
characterizing the second functionality based on comparing the determined difference with the trend performance threshold.

6. A system for generating managing infrastructure equipment comprising
a data store, executed on one or more computing devices having a processor and a memory, the data store maintaining a library of performance thresholds, wherein the library of performance thresholds include intermediate performance thresholds and trend performance thresholds;
an infrastructure maintenance scheduler, executed on one or more computing devices having a processor and a memory, the infrastructure maintenance scheduler operable to:
obtain performance information collected from a set of infrastructure equipment;
for individual infrastructure equipment,
characterize a first functionality of the respective infrastructure equipment based on applying identified one or more intermediate performance thresholds;
characterize a second functionality of the respective infrastructure equipment based on applying identified one or more trend performance thresholds, wherein the set of performance information includes at least one historical performance information; and
generate one or more notifications based on at least one of the first or second characterizations of the functionality.

7. The system as recited in claim 6, wherein the performance information corresponds to radio signal information associated with the respective infrastructure equipment.

8. The system as recited in claim 7, wherein the radio signal information corresponds to a measure of forward and return signal strength.

9. The system as recited in claim 6, wherein the performance information corresponds to antenna performance information associated with the respective infrastructure equipment.

10. The system as recited in claim 9, wherein the antenna performance information corresponds to a measured gain.

11. The system as recited in claim 6, wherein the performance information corresponds to temperature information associated with the respective infrastructure equipment.

12. The system as recited in claim 6, wherein the performance information corresponds to network connectivity information associated with the respective infrastructure equipment.

13. The system as recited in claim 6, wherein the performance information corresponds to information associated with identifiable components of the respective infrastructure equipment.

14. The system as recited in claim 6, wherein at least one of the intermediate performance thresholds or the trend performance thresholds corresponds to a minimum threshold value.

15. The system as recited in claim 6, wherein at least one of the intermediate performance thresholds or the trend performance thresholds corresponds to a maximum threshold value.

16. The system as recited in claim 6, wherein the infrastructure maintenance scheduler characterizes the second functionality of the respective infrastructure equipment based on applying the identified one or more trend performance thresholds by:
determining a difference between a current performance information and a historical performance information; and
characterizing the second functionality based on comparing the determined difference with the trend performance threshold.

17. A method for managing infrastructure equipment comprising:
obtaining performance information for a set of infrastructure equipment, wherein the performance information corresponds to data collected during operation of the infrastructure equipment in a wireless network; and
for individual infrastructure equipment in the set of infrastructure equipment:
characterizing a first functionality of the respective infrastructure equipment based on applying the identified one or more first performance thresholds;
characterizing a second functionality of the respective infrastructure equipment based on applying identified one or more second performance thresholds utilizing at least one historical performance information; and
causing maintenance of the respective infrastructure equipment based on a determining that the first or second functionality is indicative of a potential failure.

18. The method as recited in claim 17, wherein the performance information corresponds to at least one of radio signal information, antenna performance or temperature associated with the respective infrastructure equipment.

19. The method as recited in claim 17, wherein the performance information corresponds to network connectivity information associated with the respective infrastructure equipment.

20. The method as recited in claim 17, wherein the performance information corresponds to information associated with identifiable components of the respective infrastructure equipment.

21. The method as recited in claim 17, wherein at least one of the first or second performance thresholds correspond to a minimum threshold value or a maximum threshold value.

22. The method as recited in claim 17, wherein the infrastructure maintenance scheduler characterizes the second functionality of the respective infrastructure equipment based on applying the identified one or more trend performance thresholds by:
determining a difference between a current performance information and a historical performance information; and
characterizing the second functionality based on comparing the determined difference with the trend performance threshold.

23. The method as recited in claim 22, wherein the historical performance information corresponds to performance information obtained within a time window.

24. The method as recited in claim 17, wherein causing maintenance of the respective infrastructure equipment based on a determining that the first or second functionality is indicative of a potential failure includes causing maintenance of a component identified as generating the collected performance information.

25. The method as recited in claim 17, wherein causing maintenance of the respective infrastructure equipment based on a determining that the first or second functionality is indicative of a potential failure includes causing maintenance of a component identified as correlated to a component generating the collected performance information.
